(19) United States
(12) Patent Application Publication
(10) Pub. No.: US 2025/0170539 A1
(43) Pub. Date: May 29, 2025

(54) HEATING MIXER OR SOYMILK MAKER WITH SEPARATE BLADE

(71) Applicant: OCOO Co., Ltd., Boryeong-si (KR)

(72) Inventor: Sun Qyu Jung, Yongin-si (KR)

(21) Appl. No.: 18/942,183

(22) Filed: Nov. 8, 2024

(30) Foreign Application Priority Data
Nov. 23, 2023 (KR) 10-2023-0164916

(51) Int. Cl. B01F 27/07; A23C 11/10; A47J 43/046; A47J 43/07; B01F 33/80; B01F 35/00; B01F 35/90; B01F 35/92; B01F 101/14; B25B 13/48

(52) U.S. Cl. CPC B01F 27/071; A47J 43/046; A47J 43/0722; B01F 33/83612; B01F 35/165; B01F 35/92; B25B 13/481; A23C 11/103; B01F 2035/99; B01F 2101/14

(57) ABSTRACT

The present disclosure relates to a tool set for disassembly and assembly of a crusher blade. The tool set of the present disclosure may provide a dedicated hand tool that facilitates quicker and safer disassembly and assembly of the blade when separating or replacing the crusher blade. That is, during the disassembly and assembly of the blade inside the crusher container, the blade can be disassembled and assembled by rotating the fastening member for fixing the blade in the opposite direction of the fastening direction without having to hold the sharp blade directly by hand, thereby ensuring that the blade replacement or removal can be performed safely and quickly.

### CROSS-REFERENCE TO RELATED APPLICATION(S)

This application is based on and claims priority under 35 U.S.C. 119 to Korean Patent Application No. 10-2023-0164916, filed on Nov. 23, 2023, in the Korean Intellectual Property Office, the disclosure of which is herein incorporated by reference in its entirety.

### BACKGROUND OF THE INVENTION

### 1. Field of the Invention

The present disclosure relates to a crusher, such as a mixer, a heating mixer, or a soymilk maker. More particularly, the present disclosure relates to a crusher including a tool set that facilitates disassembly and assembly of a blade for crushing an object, such as food inside a container, and a method therefor.

### 2. Description of the Prior Art

Generally, a blade is assembled to a motor shaft of a mixer used for crushing objects such as vegetables and fruits, and the blade is designed and manufactured in various forms depending on the intended use. The container that accommodates a material to be crushed and the blade assembled to the motor shaft are frequently cleaned after use, and the blade is either replaced with another blade suitable for the material to be crushed or frequently disassembled and assembled for cleaning.

However, with conventional mixers, there is a risk of safety accidents, such as injuries to a hand caused by a blade when attempting to separate it by pulling it with bare hands. The blade is assembled to the motor shaft inside the container, and to replace the blade, a spanner or similar tool is used to loosen a nut assembled to the motor shaft while holding the blade or other coupling part by hand to prevent the blade coupled to the motor shaft from rotating. At this time, there are disadvantages in that, due to the narrowness of the container, it is difficult to grip the blade or other coupling parts by hand, and when the hand is sweaty or wet, the blade is slippery, making it even more difficult to replace the blade.

### SUMMARY OF THE INVENTION

Accordingly, the present disclosure has been made to solve the above-described problems, and provides a crusher, such as a mixer, a heating mixer, or a soymilk maker, including a tool set as a dedicated hand tool that is capable of assisting in the quicker and safer disassembly and assembly of a blade when separating or replacing the blade of the crusher, and a method thereof.

First, the features of the present disclosure are summarized below. In view of the foregoing, in a tool set for assisting in disassembly and assembly of a mixer blade according to an aspect of the present disclosure, the mixer includes a container configured to accommodate a material to be crushed; and at least one pair of guide portions formed on an inner wall of the container to face each other. The tool set includes: a body plate having left and right fitting portions configured to be fitted onto and slide along the pair of guide portions formed on the inner wall of the container; left and right support columns configured to come into contact with a bottom of the container to support the body plate; a guide jig including a guide through-hole formed to protrude vertically through the body plate between the left and right support columns of the body plate; a fastening member configured to be inserted into the guide through-hole; and a fastening tool with a head configured to rotate the fastening member when inserted into the guide through-holes. A central through-hole of the crushing blade is fitted onto or brought into close contact with a motor rotation shaft protruding from the bottom of the mixer between the at least one pair of guide portions of the mixer, and the fastening member is configured to be rotatable within the guide through-hole by the head of the fastening tool while the lower edge of the guide through-hole presses against an area surrounding the through-hole of the blade.

According to another aspect of the present disclosure, a method of disassembling and assembling a crusher blade using an auxiliary tool set includes: fitting or bringing a central through-hole of the crushing blade onto or into close contact with a motor rotation shaft protruding from the bottom of the crusher between the at least one pair of guide portions of the crusher; and rotating the fastening member within the guide through-hole by the head of the fastening tool while the lower edge of the guide through-hole presses against an area surrounding the through-hole of the blade.

The guide portion may include a protrusion or a groove formed vertically on the inner wall of the container.

The fastening member may include a bolt, a nut, or a screw.

The crusher may further include a lid that covers an upper end of the container, and the lid may include a window configured to allow the interior of the container to be seen.

The crusher include a heater provided under the container, and a control device configured to control the heater. The heater may include an induction heating-type induction coil provided under the container, and the control device may be configured to control power supply to the induction coil.

With a tool set and method for disassembly and assembly of the crusher blade according to the present disclosure, it is possible to provide a dedicated manual tool capable of assisting in a quicker and safer process of disassembling and assembling the blade when separating or replacing the crusher blade. That is, during the disassembly and assembly of the blade inside the crusher container, the blade can be disassembled and assembled by rotating the fastening member for fixing the blade in the opposite direction of the fastening direction without having to hold the sharp blade directly by hand, thereby ensuring that the blade replacement or removal can be performed safely and quickly.

### BRIEF DESCRIPTION OF THE DRAWINGS

The above and other aspects, features, and advantages of the present disclosure will be more apparent from the following detailed description taken in conjunction with the accompanying drawings, in which:

The accompanying drawings, which are included as part of a detailed description to aid the understanding of the present disclosure, provide embodiments of the present disclosure, and, together with the detailed description, illustrate the technical idea of the present disclosure, in which:

FIG. 1 is a schematic view illustrating the interior of a crusher according to an embodiment of the present disclosure;

FIG. 2 is a view illustrating the components of a tool set for assisting in the disassembly and assembly of a crusher blade according to an embodiment of the present disclosure;

FIG. 3 is a view illustrating the state during the separation or assembly operation of the crusher blade using the tool set of the present disclosure; and

FIG. 4 is a view illustrating a guide jig according to another embodiment of the present disclosure.

### DETAILED DESCRIPTION OF THE EXEMPLARY EMBODIMENTS

Hereinafter, the present disclosure will be described in detail with reference to the accompanying drawings. Herein, like components in each drawing are denoted by like reference numerals if possible. In addition, detailed descriptions of already known functions and/or configurations will be omitted. In the following description, components necessary for understanding operations according to various embodiments will be mainly described, and descriptions of elements that may obscure the gist of the description will be omitted. In addition, some elements in the drawings may be exaggerated, omitted, or schematically illustrated. The size of each component does not entirely reflect the actual size. Therefore, the descriptions provided herein are not limited by the relative sizes or spacings of the components drawn in each drawing.

In describing the embodiments of the present disclosure, when a detailed description of the known technology related to the present disclosure is determined to unnecessarily obscure the subject matter of the present disclosure, the detailed description will be omitted. In addition, terms to be described later are defined in consideration of functions in the present disclosure, and may vary according to the intention, custom, or the like of a user or operator. Therefore, the definitions of the terms should be made based on the description throughout this specification. Terms used in the detailed description are only for describing the embodiments of the present disclosure, and should not be construed as limiting in any way. Unless expressly used otherwise, singular expressions include the meanings of plural expressions. As used herein, expressions such as “including” or “comprising” are intended to indicate any features, numbers, steps, operations, elements, or some or combinations thereof, and should not be construed to exclude the existence or possibility of one or more other features, numbers, steps, operations, elements, or some or combinations thereof, in addition to those described above.

In addition, terms such as “first” and “second” may be used to describe various components, but the components are not limited by the terms, and these terms are only used for the purpose of distinguishing one component from another.

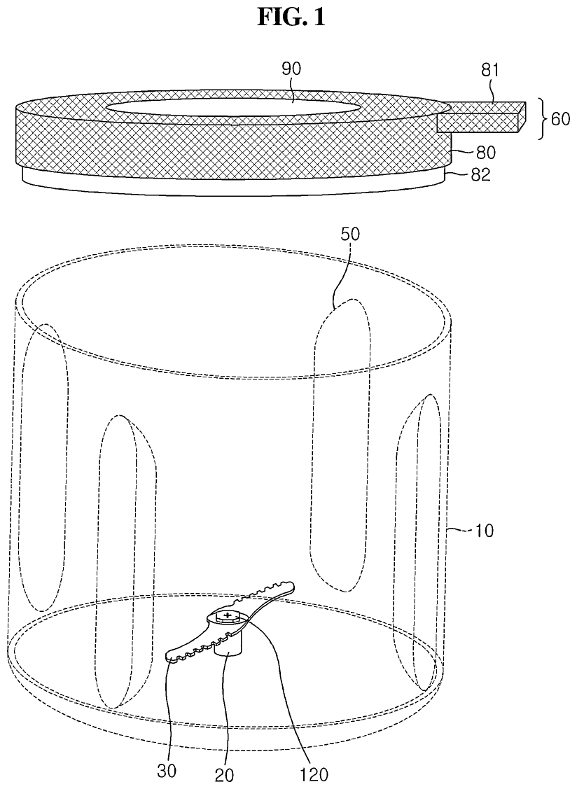

FIG. 1 is a schematic view illustrating the interior of a crusher according to an embodiment of the present disclosure.

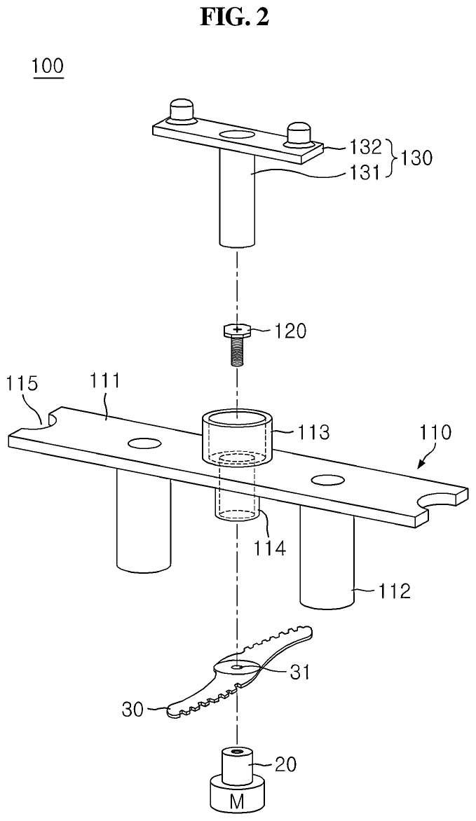

Referring to FIG. 1, a crusher according to an embodiment of the present disclosure is a device for crushing a material to be crushed, such as a vegetable or a fruit, or any other crushable materials, by placing them in a container 10, which is configured to accommodate these materials or objects, and rotating a blade 30. The blade 30 is mounted on a rotation shaft 20 of a motor M (see FIG. 2). The blade 30 may be securely assembled to the rotation shaft 20 by a fastening member 120, such as a bolt, a nut, or a screw. The crusher according to an embodiment of the present disclosure may be any of various devices capable of crushing a material to be crushed in the container 10 using the blade 30, including a mixer, a heating mixer, a soymilk maker, a juicer, and the like.

The container 10 is preferably made of a material such as aluminum or stainless steel, but in some cases, it may be made of other materials such as crystal, glass, or plastic.

The crusher according to an embodiment of the present disclosure may include a heater (not illustrated) under the container 10 for heating the material within the container 10. The heater (not illustrated) may be a type heated using a heating wire or a heating element in addition to an induction heating-type heater. Preferably, the heater (not illustrated) may include an induction heating-type induction coil provided under the container 10. The control device (not illustrated) of the crusher may control the power supply to the induction coil. In addition, the control device (not illustrated) of the crusher may perform overall control for operations such as crushing by the crusher and the operation of the heater.

Furthermore, the crusher may further include a lid 60 that covers the upper end of the container 10. The lid 60 may include a body 80 made of a metallic material such as stainless steel and a handle 81 extending from the body 80 and made of the same material as the body 80. In addition, the lid 60 may include a window 90 configured on the top surface of the body 80 to allow the interior of the container 10 to be seen. The window 90 may be made of a transparent material such as plastic or glass. Furthermore, the lid 60 may include a protrusion 82 formed on the lower side of the body 80 to be inserted and seated along the edge of the inner wall of the container 10. The protrusion 82 may be made of plastic, silicone, or, in some cases, may be made of the same metallic material as the body 80.

In particular, the crusher according to the present disclosure may include guide portions 50 formed on the inner wall of the container 10, and the guide portions 50 may include at least one pair of guide portions 50 facing each other to guide the insertion of a guide jig 110 as described later. In the drawings, two pairs of guide portions 50 facing each other are illustrated as four protrusions formed vertically on the inner wall of the container 10. However, the guide portions 50 are not limited to this and may also be grooves formed vertically on the inner wall of the container 10.

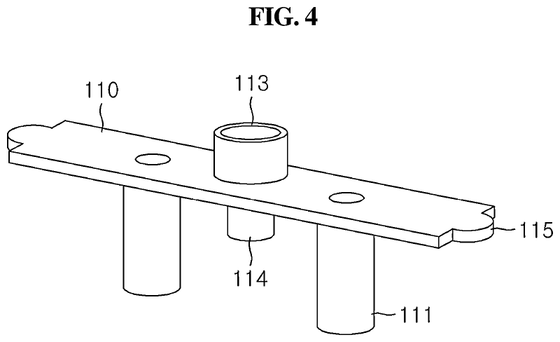

That is, when fitting portions 115 on both the left and right sides of the guide jig 110 are configured as grooves, as illustrated in FIG. 2, the fitting portions 115 may be fitted into the protrusion-type guide portions 50, as illustrated in FIG. 1, and may slide downward toward the bottom. In addition, as illustrated in FIG. 4, when the fitting portions 115 on both the left and right sides of the guide jig 110 are configured as protrusions, the fitting portions 115 may be fitted into guide portions 50 formed as vertical grooves (not illustrated) on the inner wall of the container 10 and may slide downward toward the bottom.

Hereinafter, a tool set 100 for assisting in the disassembly and assembly of the blade 30 of the crusher, such as the one illustrated in FIG. 1, according to one embodiment of the present disclosure, will be described in detail with reference to FIG. 2.

FIG. 2 is a view illustrating the components of the tool set 100 for assisting in the disassembly and assembly of the crusher blade 30 according to an embodiment of the present disclosure.

Referring to FIG. 2, the tool set 100 according to an embodiment of the present disclosure may include a guide jig 110 including a body plate 111, left and right support columns 112, and guide through-holes 113 and 114, and may further include a fastening member 120, which may be a bolt, a nut, or a screw, and a fastening tool 130 configured to rotate the fastening member 120.

FIG. 2 illustrates how the blade 30 is coupled to the rotation shaft 20 of the motor M in a driving part provided under the container 10 of the crusher illustrated in FIG. 1, by means of the fastening member 120.

The body plate 111 of the guide jig 110 has left and right fitting portions 115 configured to be slidably engaged with a pair of guide portions 50 formed on the inner wall of the container 10 of the crusher. As described above, when the fitting portions 115 on both the left and right sides of the guide jig 110 are configured as grooves, as illustrated in FIG. 2, the fitting portions 115 may be fitted into the protrusion-type guide portions 50, as illustrated in FIG. 1, and may slide downward toward the bottom. In addition, as illustrated in FIG. 4, when the fitting portions 115 on both the left and right sides of the guide jig 110 are configured as protrusions, the fitting portions 115 may be fitted into guide portions 50 formed as vertical grooves (not illustrated) on the inner wall of the container 10 and may slide downward toward the bottom.

The support columns 112 of the guide jig 110 are formed on the lower side of the body plate 111 and are respectively provided on the left and right sides to support the body plate 111 by touching the bottom of the container 10 when the body plate 111 slides down, as described above.

The guide through-holes 113 and 114 of the guide jig 110 may protrude vertically through the body plate 111, for example, at the center of the body plate 111 between the left and right support columns 112. As illustrated in the drawings, the diameter of the guide through-hole 113 on the upper side of the body plate 111 is made larger than the diameter of the guide through-hole 114 on the lower side of the body plate 111, to facilitate the insertion of the fastening tool 130 into the upper guide through-hole 113. However, the present disclosure is not limited thereto, and the guide through-holes 113 and 114, which protrude vertically through the body plate 111, may have the same diameter.

The body plate 111, the left and right support columns 112, and the guide through-holes 113 and 114, which constitute the guide jig 110 as described above, may all be integrally manufactured as a single unit. However, the present disclosure is not limited thereto, and in some cases, the body plate 11, the left and right support columns 112, and the guide through-holes 113 and 114 may be manufactured as separate components and then integrate them into a single unit by fastening them together using bolts, nuts, screws, or the like.

The fastening member 120 is a bolt, a nut, a screw, or the like, has a diameter that allows it to be inserted into the guide through-holes 113 and 114, and is used to assemble the blade 30 to the rotation shaft 20 of the motor M.

The fastening tool (130) is preferably T-shaped, including a head 131 for rotating the fastening member 120 and a handle portion 132 for the user to hold by hand. However, a straight shape without the handle portion 132 is also acceptable. The fastening tool 130 is capable of rotating the fastening member 120 through the head 131 that is inserted into the guide through-holes 113 and 114.

For example, a user may fit a central through-hole 31 of the blade 30 onto the rotation shaft 20 of the motor M, and may then insert the fastening member 120, such as a bolt or a nut into a square or hexagonal recess at the end of the head 131 of a tool, such as a wrench serving as the fastening tool 130, or insert the cross or straight-shaped protrusion at the end of the head 131 of a screwdriver tool serving as the fastening tool 130 into the cross or straight groove formed in the screw head of the fastening member 120 such as a screw. Then, the user may fix the blade 30 to the rotation shaft 20 by turning the fastening member clockwise, and may separate the blade 30 from the rotation shaft 20 by turning the fastening member counterclockwise.

In FIG. 2, an example is given where the end of the rotation shaft 20 is provided with a female screw, and the corresponding fastening member 120 is a hexagonal bolt (or screw), but the present disclosure is not limited thereto. In the case where the end of the rotation shaft 20 is provided with a male screw, the corresponding fastening member 120 may be a nut. Therefore, in FIG. 2, the area around the through-hole 31 of the blade 30 may be configured to be properly coupled to the rotation shaft 20 depending on whether the fastening member 120 is a bolt, a nut, or a screw.

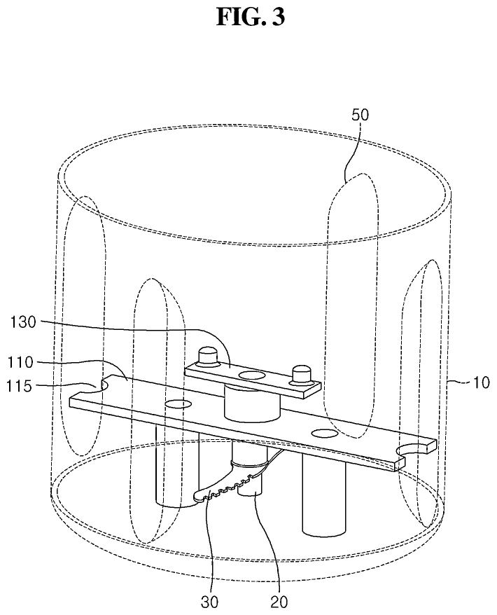

FIG. 3 is a view illustrating the state during the separation or assembly of the crusher blade 30 using the tool set 100 of the present disclosure.

Referring to FIG. 3, after the central through-hole 31 of the crushing blade 30 is fitted onto or brought into close contact with the motor rotation shaft 20 protruding from the bottom of the crusher between at least one pair of guide portions 50 formed on the inner wall of the container 10 of the crusher according to the present disclosure, as the user presses both sides of the guide jig 110, the lower end of the guide through-holes 113 and 114, that is, as the user rotates the fastening tool 130 while pressing the edge of the guide through-hole 114 on the lower side against the area surrounding the through-hole 31 of the blade 30 (the blade body portion), the fastening member 120 inserted into the guide through-holes 113 and 114 can be rotated by the head 131 of the fastening tool 130.

Since the edge of the lower guide through-hole 114 presses against the area surrounding the through-hole 31 of the blade 30 (the blade body portion), the user is able to separate or fasten the blade 30 by rotating the head 131 of the fastening tool 130 without having to directly hold the blade 30 to prevent the blade 30 from rotating.

As described above, with the tool set 100 for disassembly and assembly of the crusher blade 30 according to the present disclosure, it is possible to provide a dedicated manual tool capable of assisting in a quicker and safer process of disassembling and assembling the blade when separating or replacing the crusher blade 30. That is, during the disassembly and assembly of the blade 30 inside the container 10 of the crusher, the blade is fastened or separated by rotating the fastening member 120 for fixing the blade in the fastening direction or the reverse direction without having to hold the sharp blade by hand. Thus, the fastening member is capable of assisting in the safe and quick replacement or separation of the blade 30.

In the foregoing, the present disclosure has been described based on specific details, such as concrete components, limited embodiments, and drawings, but these have been provided merely to aid a more comprehensive understanding of the present disclosure, and the present disclosure is not limited to the above-described embodiments. Various modifications and alterations may be made without departing from the essential characteristics of the present disclosure by a person ordinarily skilled in the art to which the present disclosure pertains. Therefore, the spirit of the present disclosure should not be limited to the described embodiments, and not only the appended claims, but also all technical ideas that are equivalent or have equivalent modifications to the claims should be construed as being included within the scope of the present disclosure.

What is claimed is:

1. A method for disassembling and assembling a crusher blade using an auxiliary tool set,
wherein the crusher comprises: a container configured to accommodate a material to be crushed; and at least one pair of guide portions formed on an inner wall of the container to face each other,
wherein the tool set comprises: a body plate having left and right fitting portions configured to be fitted onto and slide along the pair of guide portions formed on the inner wall of the container; left and right support columns configured to come into contact with a bottom of the container to support the body plate; a guide jig comprising a guide through-hole formed to protrude vertically through the body plate between the left and right support columns of the body plate; a fastening member configured to be inserted into the guide through-hole; and a fastening tool with a head configured to rotate the fastening member when inserted into the guide through-holes, and
wherein the method comprises:
fitting or bringing a central through-hole of the crushing blade onto or into close contact with a motor rotation shaft protruding from the bottom of the crusher between the at least one pair of guide portions of the crusher; and
rotating the fastening member within the guide through-hole by the head of the fastening tool while the lower edge of the guide through-hole presses against an area surrounding the through-hole of the blade.

2. The method of claim 1, wherein the guide portion comprises a protrusion or a groove formed vertically on the inner wall of the container.

3. The method of claim 1, wherein the fastening member comprises a bolt, a nut, or a screw.

4. The method of claim 1, wherein the crusher further comprises a lid that covers an upper end of the container, and
wherein the lid comprises a window configured to allow an interior of the container to be seen.

5. The method of claim 1, wherein the crusher comprises a heater provided under the container, and a control device configured to control the heater, wherein the heater comprises an induction heating-type induction coil provided under the container, and wherein the control device is configured to control power supply to the induction coil.
